(19) United States
(12) Patent Application Publication
(10) Pub. No.: US 2003/0170475 A1
(43) Pub. Date: Sep. 11, 2003

(54) Biaxially oriented hydrolysis-resistant film comprising a crystallizable thermoplastic,its production and use

(76) Inventors: Holger Kliesch, Mainz (DE); Thomas Heusel, Hofheim (DE); Franz Hora, Kriftel (DE); Thorsten Kiehne, Wiesbaden (DE); Bodo Kuhmann, Runkel (DE); Gottfried Hilkert, Saulheim (DE); Christopher Hanold, Wiesbaden (DE)

Correspondence Address: ProPat, L.L.C., 2912 Crosby Road, Charlotte, NC, 28211-2815, US

(21) Appl. No.: 10/379,170

(22) Filed: Mar. 4, 2003

(30) Foreign Application Priority Data
Mar. 6, 2002 (DE) 102 09 847.6
Mar. 6, 2002 (DE) 102 09 850.6

(51) Int. Cl. H01G 2/12

(52) U.S. Cl. 428/480; 361/15; 438/190

(57) ABSTRACT

The invention relates to a biaxially oriented, hydrolysis-resistant film comprising a crystallizable thermoplastic, with a thickness in the range from 0.5 to 12 μm. The film comprises at least one hydrolysis retardant, has a conductive coating and is notable for its low hydrolysis speed and its good dielectric properties. The film may possess at least one functionality additional to the hydrolysis resistance. In particular, it has a high tracking resistance and a low dissipation factor, and may also have one or more further functionalities. The invention additionally relates to a process for producing the film and to its use.

The invention relates to a biaxially oriented, hydrolysis-resistant film comprising a crystallizable thermoplastic, with a thickness in the range from 0.5 to 12 μm. The film comprises at least one hydrolysis retardant, has a conductive coating and is notable for its low hydrolysis rate and its good dielectric properties. In particular, it has a high tracking resistance and a low dissipation factor. This film may also possess at least one functionality additional to the hydrolysis resistance. The expression “additional functionality” comprehends the shrinkage and the solderability. The invention additionally relates to a process for producing the film and to its use.

### BACKGROUND OF THE INVENTION

Films made of thermoplastics in the stated thickness range which are suitable for producing film capacitors are well known.

Films for producing capacitors are required to satisfy stringent requirements in terms of their electrical tracking resistance and their dielectric absorption, so as to ensure that the capacitor can withstand voltage to a sufficient extent and does not become very hot in the course of charging and discharging. As described in EP-A-0-791 633, inter alia, this is ensured by virtue of the high-purity raw materials employed. As a consequence it is generally necessary to forego the use of additives (exceptions being inorganic mineral additives such as the commonly used SiO₂ or CaCO₃ pigments and polymers having a very low dielectric constant such as polystyrene and the like) so as not to adversely affect the electrical properties.

In conventional film capacitors made from crystallizable thermoplastics, polyethylene terephthalate or polyethylene naphthalate homopolymers are generally employed. Polyethylene terephthalate in particular, however, tends to undergo hydrolytic degradation at temperatures above the glass transition temperature and in particular above 100° C. But with many fields of use for film capacitors, the automobile sector being one example, temperatures up to 130° C. and in some cases even higher are not infrequent. As a result of the hydrolytic degradation, the layers of film within the capacitor become fragile over time and so may lead to failure of the capacitor. Although more resistant to hydrolysis, polyethylene naphthalate (PEN) has a much higher price and is therefore uneconomic for the majority of applications; on prolonged use at the stated temperatures, it too undergoes marked degradation. The sensitivity to hydrolysis is generally increased further if, instead of the homopolymers, copolyesters such as polyethylene terephthalate (PET) with an isophthalic acid fraction are employed.

Although a certain protection against hydrolysis can be achieved by encasing the capacitors in a box comprising a water vapor barrier, this is not very effective, since in customary boxes (made, for example, of PPS) a significant water vapor pressure is built up again after a short time. Moreover, the box generates additional cost and takes up space which is not available in the ever further miniaturized electronic components. In many applications, moreover, conventional wired capacitors are no longer used, having been replaced by surface-solderable SMD (surface mounting device) capacitors.

Relatively hydrolysis-resistant polyester base materials obtained by using carbodiimides, and films and fibres produced from them, are known (U.S. Pat. No. 5,885,709, EP 0 838 500, CH 621 135). However, these base materials and films do not meet the dielectric and processing property requirements that are necessary for capacitor films.

PET films suitable for producing SMD capacitors are known and described inter alia in WO 98/13415. These films, however, have not been made hydrolysis-resistant.

It is an object of the present invention to avoid the described disadvantages of the prior art.Brief Description fo the Invention

The invention accordingly provides a biaxially oriented, hydrolysis-resistant film which comprises a crystallizable thermoplastic as main constituent and has a thickness in the range from 0.5 to 12 μm, preferably from 1.2 to 7.0 μm, has AC electrical tracking resistance≧190 kV/mm and roughness Rₐ≦150 nm, comprises at least one hydrolysis stabilizer, has a conductive coating, and may have been provided with at least one further functionality. The invention further provides a process for producing this film, and its use.

### DETAILED DESCRIPTION OF THE INVENTION

The film according to the invention is notable for its hydrolysis resistance and high tracking resistance. In addition it possesses a low dielectric absorption (i.e., a low dielectric dissipation factor), is economic to produce, and, on account of its conductive coating, is suitable for producing electrically stable capacitors which are likewise hydrolysis-resistant and may be SMD solderable. An SMD capacitor of this kind requires no box, therefore offers the advantage of occupying a particularly small space and has a longer lifetime than capacitors comprising unstabilized thermoplastics.

Furthermore, the film according to the invention can be recycled without loss of its properties before it is coated; in other words, the regrind can be used again.

High tracking resistance means that the tracking resistance of the film as measured in accordance with DIN 53481 by the ball and plate method with alternating current (AC) is ≧190 kV/mm, preferably ≧240 kV/mm, and in particular ≧280 kV/mm.

A low dielectric dissipation factor (tan delta) is one which at 30° C. and 1 kHz has values of ≦0.0075, preferably ≦0.0055, and in particular ≦0.0050, and at 120° C. and 1 kHz has values of ≦0.03, preferably ≦0.022, and in particular ≦0.019.

The expression “electrically stable capacitors” means that the capacitors equipped with hydrolysis stabilizers possess a significantly prolonged life time and in practical use do not exhibit high failure rates as compared with capacitors which have not been made hydrolysis-stable.

SMD-solderable means that at the 220° C.-plus temperatures customary for reflow soldering the capacitors are not mechanically deformed and remain electrically stable.

As its main constituent the film comprises a crystallizable thermoplastic. Examples of suitable crystallizable or partly crystalline thermoplastics are polyethylene terephthalate (PET), polyethylene naphthalate (PEN), polybutylene terephthalate (PBT), bibenzoyl-modified polyethylene terephthalate (PETBB), bibenzoyl-modified polybutylene terephthalate (PBTBB), bibenzoyl-modified polyethylene naphthalate (PENBB) or mixtures of these, preference being given to PET, PEN, and PETBB.

For producing the thermoplastics, in addition to the principal monomers such as dimethyl terephthalate (DMT), ethylene glycol (EG), propylene glycol (PG), 1,4-butanediol, terephthalic acid (TA), benzenedicarboxylic acid and/or 2,6-naphthalenedicarboxylic acid (NDA), it is also possible to use isophthalic acid (IPA), trans- and/or cis-1,4-cyclohexanedimethanol (C-CHDM, t-CHDM or c/t-CHDM), and other suitable dicarboxylic acid components (or dicarboxylic esters) and diol components.

In accordance with the invention crystallizable thermoplastics are

crystallizable homopolymers,

crystallizable copolymers,

compounds of crystallizable thermoplastics,

crystallizable recyclate, and

other types of crystallizable thermoplastics.

Preferred polymers are those wherein 95% or more, in particular 98% or more, of the dicarboxylic acid component is composed of TA or NDA. Preference extends to thermoplastics wherein 90% or more, in particular 93% or more, of the diol component is composed of EG. Other preferred polymers are those wherein the proportion of diethylene glycol as a fraction of the overall polymer is in the range from 1 to 2%. In all of the above quantities the hydrolysis stabilizer remains disregarded.

The film according to the invention further comprises organic or inorganic compounds which are needed in order to adjust the surface topography. Too high a roughness (Rₐ), however, adversely affects the electrical yield in capacitor manufacture. It is therefore proven advantageous to set the roughness values described below, which may vary depending on the thickness of the film. The amount of the compounds used is dependent on the substances used and their particle size. Said particle size is situated in the range from 0.01 to 10.0, preferably from 0.1 to 5.0, and in particular from 0.3 to 3.0 μm. In the case of a film with a thickness of 3.6-12.0 μm the target Rₐ is ≦150 nm and preferably ≦100 nm. In the case of a film with a thickness of 2.4 to 3.5 μm the Rₐ is ≦100 nm and preferably ≦70 nm, while at film thicknesses below 2.4 μm it is ≦70 nm and preferably ≦50 nm.

Examples of compounds suitable for achieving the roughness include calcium carbonate, apatite, silica, titanium dioxide, alumina, crosslinked polystyrene, zeolites, and other silicates and aluminosilicates. These compounds are used in general in amounts from 0.05 to 1.5%, preferably from 0.1 to 0.6%. The roughness can easily be determined for a particular compound used, by means of simple mixing experiments with subsequent measurement of the Rₐ values. By way of example, a combination of the silica pigments 0.11% ®Sylysia 320 (Fuji, Japan) and 0.3% ®Aerosil TT600 (Degussa, Germany) in a 5 μm film leads to an Rₐ of 70 nm. Similarly, a film 5 μm thick and containing 0.6% ®Omyalite (calcium carbonate from Omya, Switzerland) with an average particle size of 1.2 μm has an Rₐ of 60 nm. Using the same formulations to produce a film 1.4 μm thick gives an Rₐ of 35±5 nm.

In order to achieve the tan delta electrical dissipation factor and the AC tracking resistance it has proven advantageous for the melt resistance of the thermoplastic used to possess on average a value ≧1·10⁷Ω·cm, preferably ≧10·10⁷·Ωcm, and in particular ≧25·10⁷Ω·cm. The average value is calculated in accordance with the formula

1/(x₁·1/W₁+x₂·1/W₂+. . . +xₙ·1/Wₙ)

where

x₁(xₙ) is the fraction of the thermoplastic chips of component 1(n) and

W₁(Wₙ) is the resistance of the thermoplastic chips of component 1(n).

The standard viscosity SV (DCA) of the film, measured in dichloroacetic acid in accordance with DIN 53728, is situated generally in the range from 700 to 1100, preferably from 800 to 980.

The film further comprises a hydrolysis stabilizer, which is preferably metered in directly in the course of film production by way of what is called masterbatch technology, the fraction of the hydrolysis stabilizer being in the range from 0.2 to 10.0% by weight, preferably from 1.0 to 4.0% by weight, based on the weight of the crystallizable thermoplastic. In the masterbatch the fraction of the hydrolysis stabilizer is generally from 5.0 to 60.0% by weight, preferably from 10.0 to 50.0% by weight, based in each case on the total weight of the masterbatch.

Examples of suitable hydrolysis stabilizers are carbodiimides, preferably polymeric carbodiimides, such as ®P100 (from Rheinchemie, Germany) or ®Stabilisator 9000 (from Raschig, Germany).

Besides the aforementioned additives, the film may further comprise other components such as flame retardants and/or free-radical scavengers and/or other polymers such as polyetherimides.

The hydrolysis stabilizer is preferably added by way of masterbatch technology. First of all, it is completely dispersed in a carrier material. Suitable carrier material includes the thermoplastic itself, e.g., the polyethylene terephthalate, or else other polymers which are compatible with the thermoplastic. After the masterbatch has been metered into the thermoplastic for film production, its constituents melt in the course of extrusion and so are dissolved in the thermoplastic.

The masterbatch may also be prepared in situ: that is, the monomers for preparing the thermoplastic are mixed together with the other components, for example, the hydrolysis stabilizers and/or the compounds used for attaining roughness, and the mixtures obtained are subjected to polycondensation.

Part of an economic production process is that the raw materials or raw-material components needed to produce the film can be dried using standard commercial industrial driers, such as vacuum driers (i.e., those which operate under reduced pressure), fluidized-bed driers or fixed-bed driers (tower driers). It is important that the raw materials used in accordance with the invention do not cake or undergo thermal degradation. The driers mentioned operate generally at temperatures between 100 and 170° C. under atmospheric pressure, conditions under which raw materials made hydrolysis-stable in accordance with the prior art may cake and clog up the driers and/or extruders. In the case of a vacuum drier, which permits the gentlest drying conditions, the raw material passes through a temperature range from about 30° C. to 130° C. under a reduced pressure of 50 mbar. Even with these driers, with drying temperatures below 130° C., the capacitor film production process requires afterdriers (hoppers) with temperatures above 100° C., where prior art corresponding raw materials may undergo caking. Generally speaking, afterdrying in a hopper at temperatures from 100 to 130° C. and a residence time of from 3 to 6 hours is required.

The film according to the invention is generally produced by extrusion processes which are known per se.

The procedure adopted in one of these processes is that the melts in question are extruded through a flat film die, the resulting film is drawn off as a substantially amorphous prefilm for solidification on one or more rolls (chill roll) and quenched, the film is then reheated and subjected to biaxial stretching (orienting), and the biaxially oriented film is heat-set.

Biaxial orientation is generally carried out sequentially. In sequential stretching, orientation takes place preferably first in the longitudinal direction (i.e., machine direction, MD) and then in the transverse direction (TD, transverse with respect to the machine direction). This process results in orientation of the molecule chains. Stretching in the longitudinal direction can be carried out using two rolls which run at different speeds depending on the target draw ratio. For transverse stretching an appropriate tenter frame is generally employed.

The temperature at which orientation is carried out may vary over a relatively wide range and is guided by the desired film properties. Generally speaking, both longitudinal and transverse stretching are carried out at T_{g}+10° C. to T_{g}+60° C. (where T_{g} is the glass transition temperature of the film). The longitudinal draw ratio is generally in the range from 2.0:1 to 6.0:1, preferably from 3.0:1 to 4.5:1. The transverse draw ratio is generally in the range from 2.0:1 to 5.0:1, preferably from 3.0:1 to 4.5:1, and that of the optional second longitudinal and transverse stretching is from 1.1:1 to 5.0:1.

The first longitudinal stretching may, where appropriate, be carried out at the same time as transverse stretching (simultaneous stretching). It has proven particularly advantageous if the draw ratio in the longitudinal and transverse directions is greater than 3.5 in each case.

In the subsequent heat-setting operation, the film is held for a period of about 0.1 to 10 s at a temperature of from 180° C. to 260° C., preferably from 220 to 245° C. Either subsequent to heat-setting or commencing during heat-setting the film is relaxed by from 0 to 15%, preferably by from 1.5 to 8% in the transverse direction and, where appropriate, in the longitudinal direction as well, and the film is cooled in a usual manner and wound up.

In a preferred embodiment for SMD capacitors the film during subsequent heat-setting is held for a period of about 0.1 to 10 s at a temperature of from 180 to 260° C., preferably from 220 to 245° C. Following and/or during heat-setting the film, preferably in at least two stages, is relaxed transversely by a total of from 4 to 15%, preferably by from 5 to 8%, at least the final 2% of the total relaxation taking place at temperatures below 180° C., preferably from 180 to 130° C. Thereafter the film is cooled in the usual manner and wound up. Relaxation may also take place longitudinally.

In order to attain the specified tracking resistances and the desired electrical stability of the capacitors it has proven advantageous if the lengthwise fluctuation in the thickness of the film is generally not more than 20%, preferably of less than 15%, and in particular of less than 10% of the film thickness, based on the average thickness of the film. In this context it is advantageous if the temperatures in the extrusion region (die+melt line+extruder) are in the order of magnitude of Tₛ (Tₛ=melting point of the film)+20 to +50° C. Particularly suitable temperatures range from Tₛ+30 to Tₛ+45° C.

The wound film is subsequently metalized in conventional metalizing machines (e.g., from Applied Films, formerly Leybold) by the known methods (coating with another conductive material such as conductive polymers is likewise possible) and converted into the desired width for capacitor production. These narrow metalized strips are used to manufacture capacitor windings, which are then pressed flat (at temperatures between 0 and 280° C.), schooped, and contacted.

Following metalization (or other conductive coating), in a preferred embodiment, the film has longitudinal shrinkage ≦5% at 200° C. (15 min), preferably ≦4%, and in particular ≦3.5%. However, this longitudinal shrinkage is not less than 1%. The transverse shrinkage at 200° C. (15 min) possesses values of ≦2%, preferably ≦1%, and in particular ≦0.5%. The shrinkage figure in TD is, however, always ≧−0.5%.

A further possibility is the winding of the narrow strips into wheels or rods which are schooped, heat-stabilized in an oven (at temperatures between 100 and 280° C.), and slit to the corresponding capacitor widths (film capacitors), which are then finally contacted. Thermal conditioning may also take place, where appropriate, prior to schooping.

It is surprising that despite being furnished with the hydrolysis stabilizer the film according to the invention does not have an intolerably higher dielectric dissipation factor (tangent) than comparably produced films without this addition.

The lifetime of capacitors comprising films equipped with hydrolysis stabilizers is increased by a factor of more than two as compared with capacitors comprising conventional films. It is also surprising here that the lifetime of the capacitors produced from PEN films with hydrolysis stabilizer is further markedly increased and is situated in the range of capacitors based on polyphenylene sulfide (PPS).

Also particularly surprising was the high tracking resistance of the films according to the invention, and the very good electrical properties. Accordingly, the films are especially suitable for producing capacitors, preferably starter capacitors. These capacitors, accordingly, do not exhibit relatively high failure rates in voltage testing and in their lifetime when high flows of electricity pass through.

In the examples below, the individual properties are measured in accordance with the cited standards and methods.

Standard Viscosity (SV) and Intrinsic Viscosity (IV)

Based on DIN 53726, the standard viscosity SV (DCA) is measured at 25° C. in dichloroacetic acid. The intrinsic viscosity (IV) is calculated from the standard viscosity as follows

IV=[ρ]=6.907·10⁻⁴SV(DCA)+0.063096[dl/g].

Roughness

The roughness Ra of the film is determined in accordance with DIN 4768 with a cut-off of 0.25 mm.

Electrical Tracking Resistance

The electrical tracking resistance is reported in accordance with DIN 53481 as the mean of 10 measurement sites under alternating voltage (50 Hz).

Dissipation Factor (Tangent Delta)

The dissipation factor is determined along the lines of DIN 53483.

Voltage Testing

A voltage is applied for 2 seconds to each of 100 examples of the manufactured capacitors. The voltage depends on the thickness of the film used and is calculated as follows: voltage (in volts)=69·(thickness in μm)^{1.3629}.

The voltage test is passed for each capacitor if over the two seconds the voltage does not decrease by more than 10%. The overall test is passed if not more than 2 of the capacitors used fail.

Lifetime

100 capacitors are stored for 500 hours in an autoclave at 125° C. and a relative humidity of 50% and before and after this time are subjected to the voltage test. The test is passed if not more than 2 of the capacitors used, which passed the voltage test at the start, fail after thermal conditioning.

Lengthwise Fluctuation in Thickness

The thickness is measured on a film strip 10 meters long, either continuously by means of capacitive thickness measurement or every 2 cm using a gage. The minimum thickness measured is subtracted from the maximum and the result is expressed as a percentage of the average thickness.

Melt Conductivity/Melt Resistance

15 g of raw material are introduced into a glass tube and dried at 180° C. for 2 hours. The tube is immersed in an oil bath, which is at 285° C., and is evacuated. The melt is rendered bubble-free (defoamed) by lowering the pressure in steps to 0.1·10⁻² bar. The tube is then flooded with nitrogen and two electrodes (two platinum sheets (A=1 cm²) at a distance of 0.5 cm from one another), preheated to 200° C., are slowly dipped into the melt. Measurement takes place after 7 minutes at a voltage of 100 V (high resistance meter 4329 A from Hewlett Packard), the measured value being taken two seconds following application of the voltage.

Shrinkage

The thermal shrinkage is determined on 10 cm squares cut from the film. The edge length of the unheated samples (L₀) is measured precisely and the samples are heated at the respective temperature in a forced-air drying cabinet for 15 minutes. The heated samples (L) are taken from the drying cabinet and a corresponding lengthwise edge is subjected to precise comparative measurement at room temperature.

$$Shrinkage ( \% ) = \frac{{L}_{0} - L}{{L}_{0}} \times 100$$

SMD Solderability

The capacitors produced from the film are subjected to heat treatment in an oven at 235° C. for 2 minutes. They are then subjected to the voltage test as indicated above. The test, however, is only passed if there is no perceptible deformation of the capacitors. Under realistic conditions, deformed capacitors cannot be soldered.

### EXAMPLES 1 TO 7 (INVENTIVE) AND C1 to C4 (COMPARATIVE)

Films differing in thickness (see Table 1) were produced as described below. They were used to manufacture capacitors, again as described below.

Film Production (Examples 1-4 (Inventive) and C1 and C2 (Comparative))

Thermoplastic chips were mixed in the proportions indicated in the examples and precrystallized in a fluidized-bed drier at 155° C. for 1 minute, then dried in a tower drier at 150° C. for 3 hours and extruded at 290° C. The melted polymer was drawn off from a die by way of a take-off roll. The film was oriented by a factor of 3.8 in machine direction at 116° C. and transverse orientation by a factor of 3.7 was carried out in a frame at 110° C. The film was subsequently heat-set at 230° C. and relaxed transversely by 4% at temperatures of 200 to 180° C.

Capacitor Production (Examples 1-4 (Inventive) and C1 and C2 (Comparative))

Each film was vapor-deposited with a layer of aluminum about 500 angstroms thick, masking tapes being used to produce an unmetalized strip of 2 mm in width between metalized strips each 18 mm wide, and the film was then slit into strips 10 mm wide, so that the unmetalized strip 1 mm wide remains at the edge (free edge). Two strips each three meters long, one with the free edge on the left-hand side and one with the free edge on the right-hand side, are wound together on a metal rod with a diameter of three mm. The offset of the two strips in the widthwise direction is 0.5 mm. The windings are subsequently subjected to flat pressing at 50 kg/cm² and 140° C. for 5 minutes. The resulting windings are schooped on both sides and provided with contact wires.

Film Production (Examples 5-7 (Inventive) and C3-C4 (Comparative))

Thermoplastic chips and the other constituents were mixed in the proportions indicated in the examples and precrystallized in a fluidized-bed dryer at 155° C. for 1 minute, then dried in a tower dryer at 150° C. for 3 hours and extruded at 290° C. The melted polymer was drawn off from a die by way of a take-off roll. The film was oriented by a factor of 3.8 in machine direction at 116° C. and transverse orientation by a factor of 3.7 was carried out in a frame at 110° C. The film was subsequently heat-set at 239° C. and relaxed transversely by 4% at temperatures of 230-190° C. and then again by 3% at temperatures of 180-130° C.

Capacitor Production (Examples 5-7 (Inventive) and C3-C4 (Comparative))

The film was vapor-deposited in each case with a layer of aluminum about 500 Ångstroms thick, masking tapes being used to produce an unmetallized strip 2 mm in width between metallized strips each 18 mm wide, and the film was then slit into strips 10 mm wide, so that the unmetallized strip 1 mm wide remains at the edge (free edge). Two strips each 600 meters long, one with the free edge on the left-hand side and one with the free edge on the right-hand side, were wound together on a metal wheel with a diameter of 20 cm. The offset of the two strips in the widthwise direction was 0.5 mm. Above and below the metallized strips, 10 plies of unmetallized film were wound in each case. A metal strip was fastened over the topmost ply with a pressure of 0.1 kg/cm². The winding on the wheel was then schooped on both sides, vapor-coated with a layer of silver 0.2 mm thick, and heat-treated in an oven (flooded with dry nitrogen) at 195° C. for 60 minutes. The metal strip was then removed from the winding wheel and cut into individual capacitors at intervals of 0.7 cm. ps Raw Materials Used

Raw material R1: PET (type M 03, KoSa), SV 820

Raw material R2: PEN, SV 900

Masterbatch MB1: 15.0% by weight stabilizer 9000 and 85.0% by weight PET, SV 860

Masterbatch MB2: 1.0% by weight Sylysia 320, 3.0% by weight Aerosil TT600 and 96.0% by weight PET, SV 800

Masterbatch MB3: 15.0% by weight stabilizer 9000 and 85.0% by weight PEN, SV 900

Masterbatch MB4: 1.0% by weight Sylysia 320, 3.0% by weight Aerosil TT600 and 96.0% by weight PEN, SV 900

The melt resistance of the raw materials used was in the range from 25·10⁷ to 30·10^{7Ω·cm.}

The films were produced with the compositions given in Table 1.

TABLE 1

| | Film | |
|---|---|---|
| | thickness | |
| Example | (μm) | Composition |
| 1 | 2 | 11.0% by weight MB2, 10.0% by weight MB1 |
| | | and 79.0% by weight R1 |
| 2 | 6 | 8.0% by weight MB2, 10.0% by weight |
| | | MB1 and 82.0% by weight R1 |
| 3 | 6 | as Example 2, but extrusion |
| | | temperature 270° C. |
| 4 | 6 | 8.0% by weight MB4, 10.0% by weight |
| | | MB3 and 82.0% by weight R2, extrusion |
| | | temperature 305° C.; |
| | | orientations at 141° C. |
| 5 | 2 | 11.0% by weight MB2, 10.0% by weight |
| | | MB1 and 79.0% by weight R1 |
| 6 | 6 | 8.0% by weight MB2, 10.0% by weight |
| | | MB1 and 82.0% by weight R1 |
| 7 | 6 | 8.0% by weight MB4, 10.0% by weight |
| | | MB3 and 82.0% by weight R2, extrusion |
| | | temperature 305° C., orientations |
| | | at 141° C. The film was subsequently |
| | | heat-set at 247° C. and relaxed |
| | | transversely by 4% at temperatures of |
| | | 247-190° C. and then again by |
| | | 3% at temperatures of 180-150° C. |
| C1 | 2 | 11.0% by weight MB2 and 89.0% by weight R1 |
| C2 | 6 | 8.0% by weight MB2 and 92.0% by weight R1 |
| C3 | 2 | 11.0% by weight MB2, 20.0% by weight |
| | | MB1 and 69.0% by weight R2 |
| | | In the case of this example, unlike inventive |
| | | example 5, the film was relaxed transversely |
| | | only by 4% at temperatures of 200-180° C., |
| | | i.e., at a lower ratio. |
| C4 | 2 | 11.0% by weight MB2 and 89.0% by weight R1 |

The properties of these films and of the capacitors produced from them are evident from Table 2.

Whereas in examples 1 to 4, i.e., in the examples according to the invention, the hydrolysis resistance of the capacitors is excellent, the hydrolysis resistance and thus the lifetime in the comparative examples 1 and 2, is unsatisfactory. In examples 5 to 7, i.e., in the examples in accordance with the invention, the hydrolysis resistance of the capacitors is excellent and the capacitors are SMD solderable. In comparative example 3 the hydrolysis resistance is excellent but SMD solderability is absent. In comparative example 4 there is no hydrolysis resistance but the SMD solderability is excellent.

TABLE 2

| | | Examples | | | | | |
|---|---|---|---|---|---|---|---|
| Properties | | 1 | 2 | 3 | 4 | C1 | C2 |
| Thickness | μm | 1.97 | 5.98 | 5.97 | 5.95 | 1.96 | 6.03 |
| Roughness Rₐ | nm | 41 | 54 | 51 | 62 | 38 | 55 |
| Tracking resistance | V/μm | 304 | 315 | 294 | 318 | 312 | 320 |
| Tangent at 120° C., 1 kHz | | 0.018 | 0.017 | 0.017 | 0.012 | 0.014 | 0.013 |
| Tangent at 30° C., 1 kHz | | 0.0049 | 0.0048 | 0.0049 | 0.0043 | 0.0045 | 0.0044 |
| Voltage testing | +/− | + | + | (+) | + | + | + |
| Lifetime | +/− | + | + | + | ++ | − | − |
| Lengthwise fluctuation in | % | 8 | 5 | 22 | 10 | 9 | 3 |
| thickness | | | | | | | |
| SV | | 883 | 894 | 887 | 895 | 783 | 775 |

+ = good
++ = very good
(+) = moderate
− = poor

TABLE 3

| | | Examples | | | | |
|---|---|---|---|---|---|---|
| Properties | | 5 | 6 | 7 | C4 | C3 |
| Thickness | μm | 1.97 | 5.98 | 5.95 | 1.96 | 1.98 |
| Roughness Ra | nm | 39 | 55 | 62 | 37 | 36 |
| Tracking resistance | V/μm | 301 | 301 | 312 | 319 | 315 |
| Tangent at 12000, 1 kHz | | 0.0179 | 0.0188 | 0.014 | 0.015 | 0.0172 |
| Tangent at 3000, 1 kHz | | 0.0045 | 0.0049 | 0.0047 | 0.0045 | 0.0048 |
| Voltage testing | +/− | + | + | + | + | + |
| Lifetime | +/− | + | + | ++ | − | + |
| SMD solderability | +/− | + | + | + | + | − |
| Lengthwise fluctuation in | % | 9 | 7 | 6 | 8 | 4 |
| thickness | | | | | | |
| SV | | 883 | 894 | 895 | 780 | 886 |

+ = good
++ = very good
(+) = moderate
− = poor

1. A biaxially oriented, hydrolysis-resistant film which comprises a crystallizable thermoplastic as main constituent and which film has a thickness in the range from about 0.5 to about 12.0 μm, wherein the film has an AC electrical tracking resistance of ≧about 190 kV/mm, comprises at least one hydrolysis stabilizer and has a conductive coating.

2. The film as claimed in claim 1, wherein the crystallizable thermoplastic is a polyethylene terephthalate, polybutylene terephthalate, polyethylene naphthalate, bibenzoyl-modified polyethylene terephthalate, or a mixture of these.

3. The film as claimed in claim 1, wherein the concentration of the hydrolysis stabilizer is in the range from about 0.2 to about 10.0% by weight, based on the weight of the crystallizable thermoplastic.

4. The film as claimed in claim 1, wherein carbodiimides, polymeric carbodiimides, are present as hydrolysis stabilizers.

5. The film as claimed in claim 4, wherein the carbodiimide is a polymeric carbodiimide.

6. The film as claimed in claim 1, which has a tangent delta dissipation factor at 1 kHz and 30° C. of ≦about 0.0075 and a tangent delta at 1 kHz and 120° C. of ≦about 0.3.

7. The film as claimed in claim 1, which has a further functionality.

8. A process for producing a biaxially oriented, hydrolysis-resistant film which comprises a crystallizable thermoplastic as main constituent and which film has a thickness in the range from about 0.5 to about 12 μm, which comprises extruding a crystallizable thermoplastic and a hydrolysis stabilizer to give a flat melt film, quenching the film, and drawing off the resultant substantially amorphous film for solidification on one or more rolls, then biaxially stretching (orienting) the film and heat-setting the biaxially stretched film and winding the film up and providing it with a conductive coating.

9. The process as claimed in claim 8, wherein, after the biaxial orientation, the film is heat-set and relaxed transversely by a total of from about 4 to about 15%, at least the final 2% of the total relaxation taking place at temperatures below about 180° C.

10. The process as claimed in claim 8, wherein the hydrolysis stabilizer is present in a masterbatch together with the thermoplastic in amounts of from about 5.0 to about 60.0% by weight, based in each case on the total weight of the masterbatch.

11. The process as claimed in claim 9, wherein the final 2% of the total relaxation of the film is undertaken at temperatures of from about 180 to about 130° C. and the total transverse relaxation is from about 5 to about 8%.

12. Method of making a capacitor which method comprises converting a film according to claim 1 into a capacitor.

13. The method as claimed in claim 12 wherein the capacitor is an SMD capacitor.

14. The method as claimed in claim 12 wherein the capacitor is a starter capacitors.

15. The method as claimed in claim 12 wherein the capacitor is a suppression capacitor.

16. A starter capacitor produced with a film as claimed in claim 1.

17. A suppression capacitor produced with a film as claimed in claim 1.

18. An SMD capacitor produced with a film as claimed in claim 1.
